(19) United States
(12) Patent Application Publication
(10) Pub. No.: US 2026/0350499 A1
(43) Pub. Date: Nov. 5, 2026

(54) SYSTEMS AND METHODS TO TRACK USER ACTIVITY WITHIN A COLLABORATION ENVIRONMENT AND/OR GENERATE ACTIVITY LOGS FOR ACTIVITY THAT ACCOUNTS FOR SUBSTANTIVE PROGRESS TOWARD COMPLETION OF WORK

(71) Applicant: Asana, Inc., San Francisco, CA (US)

(72) Inventor: Rohan Seth, San Mateo, CA (US)

(21) Appl. No.: 18/184,445

(22) Filed: Mar. 15, 2023

(51) Int. Cl. G06Q 10/0631; G06F 3/0482; H04L 67/50

(52) U.S. Cl. CPC G06Q 10/063114; H04L 67/535; G06F 3/0482

(57) ABSTRACT

Systems and methods to track user activity within a collaboration environment and/or generate activity logs for activity that accounts for substantive progress toward completion of work are described herein. Exemplary implementations may perform one or more of: manage environment state information maintaining a collaboration environment; monitor the collaboration environment to identify user activity that accounts for substantive progress toward completion of work; generate activity logs; identify activity content; generate user interface information; effectuate presentation of a user interface of the collaboration environment; and/or other operations.

### FIELD OF THE DISCLOSURE

The present disclosure relates to systems and methods to track user activity within a collaboration environment and/or generate activity logs for activity that accounts for substantive progress toward completion of work.

### BACKGROUND

Web-based collaboration environments, sometimes referred to as work management platforms, may enable users to assign projects, tasks, or other assignments to assignees (e.g., other users) to complete. A collaboration environment may comprise an environment in which individual users and/or a virtual team of users does its work and enables the users to work in a more organized and efficient manner when remotely located from each other.

### SUMMARY

Hosting a web-based collaboration environment poses many challenges. For example, operating the collaboration environment may require precise ways of creation, storage, management, and/or provision of information that makes up the collaboration environment. One way that operators look to improve the operation of the collaboration environment is to improve how user interfaces provide access to information making up the collaboration environment. By way of non-limiting illustration, information making a project may be stored in a fractured nature such that some information may reside in a task record for a task that supports fulfillment of the project, while other information may reside in another task record for another task that supports fulfillment of the project. Accordingly, navigation through a series of user interfaces and/or pages may be required to hone in on particular pieces of critical information. Navigation through many pages of a user interface may not only be time consuming, but may also not provide clear direction as to where critical information may reside. For example, stakeholders of a project may desire an understanding of critical activity or decisions that were made to help fulfil the project. The fractured nature of such information, and the deficiencies of current user interface functionality makes this a difficult task. To address these and/or other problems, one or more implementations presented herein propose aggregating electronically stored information-which would otherwise reside across many user interfaces and/or pages-into centralized activity logs for activity that accounts for substantive progress toward completion of work. The activity logs may be presented within a user interface in a manner which not only provides an indication of the activity that accounts for substantive progress toward completion of work, but also allows for navigation directly to source pages or user interfaces of that activity.

One or more implementations of a system configured to track user activity within a collaboration environment and/or generate activity logs for activity that accounts for substantive progress toward completion of work may include one or more hardware processors configured by machine-readable instructions and/or other components. Executing the machine-readable instructions may cause the one or more hardware processors to facilitate one or more features and/or functions presented herein. The machine-readable instructions may include one or more computer program components. The one or more computer program components may include one or more of an environment state component, a user interface component, an activity log component, and/or other components.

The environment state component may be configured to manage environment state information maintaining a collaboration environment. The collaboration environment may be configured to facilitate interaction by users with the collaboration environment. The environment state information may include one or more records. The records may include work unit records and/or other records. The work unit records may describe units of work created, managed, and/or assigned within the collaboration environment. By way of non-limiting illustration, the work unit records may include a first work unit record for a first unit of work.

The environment state component may be configured to monitor the collaboration environment to identify user activity that accounts for substantive progress toward completion of one or more of the units of work of one or more of the work unit records. By way of non-limiting illustration, identified user activity may include one or more of first user activity, second user activity, and/or other user activity within the collaboration environment that accounts for the substantive progress toward completion of the first unit of work.

The activity log component may be configured to generate, for individual ones of the work unit records, individual activity logs of user activity that account for the substantive progress toward the completion of individual ones of the units of work. By way of non-limiting illustration, a first activity log may be generated for the first work unit record. The first activity log may indicate one or more of the first user activity, the second user activity, and/or other user activity within the collaboration environment that accounts for the substantive progress toward completion of the first unit of work.

The activity log component may be configured to identify, for the user activity that accounts for the substantive progress toward the completion of the individual ones of the units of work, activity content within the collaboration environment making up the user activity. By way of non-limiting illustration, first activity content may be identified as making up the first user activity, and second activity content may be identified as making up the second user activity.

The user interface component may be configured to generate user interface information defining a user interface of the collaboration environment. The user interface may display individual activity logs. The display of the individual activity logs within the user interface may include display of instances of the activity content. By way of non-limiting illustration, first user interface information may define the user interface through which the first activity log is displayed.

The user interface component may be configured to effectuate presentation of the user interface on computing platforms of the users based on the user interface information and/or other information. By way of non-limiting illustration, the user interface displaying the first activity log may be presented on a first computing platform of a first user. The user interface may display the first activity by including one or more of an instance of the first activity content, an instance of the second activity content, and/or other content as part of the first activity log of the first work unit record.

Selections of the instance of activity content may cause the user interface to navigate to source pages that include the activity content.

As used herein, any association (or relation, or reflection, or indication, or correspondency) involving servers, processors, client computing platforms, and/or another entity or object that interacts with any part of the system and/or plays a part in the operation of the system may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates a system configured to track user activity within a collaboration environment and/or generate activity logs for activity that accounts for substantive progress toward completion of work, in accordance with one or more implementations.

FIG. 2 illustrates a method to track user activity within a collaboration environment and/or generate activity logs for activity that accounts for substantive progress toward completion of work, in accordance with one or more implementations.

FIG. 3 illustrates a user interface of a collaboration environment showing an activity log, in accordance with one or more implementations.

FIG. 4 illustrates a user interface of a collaboration environment showing a work unit page for a completed unit of work, in accordance with one or more implementations.

FIG. 5 illustrates a user interface of an external resource, in accordance with one or more implementations.

### DETAILED DESCRIPTION

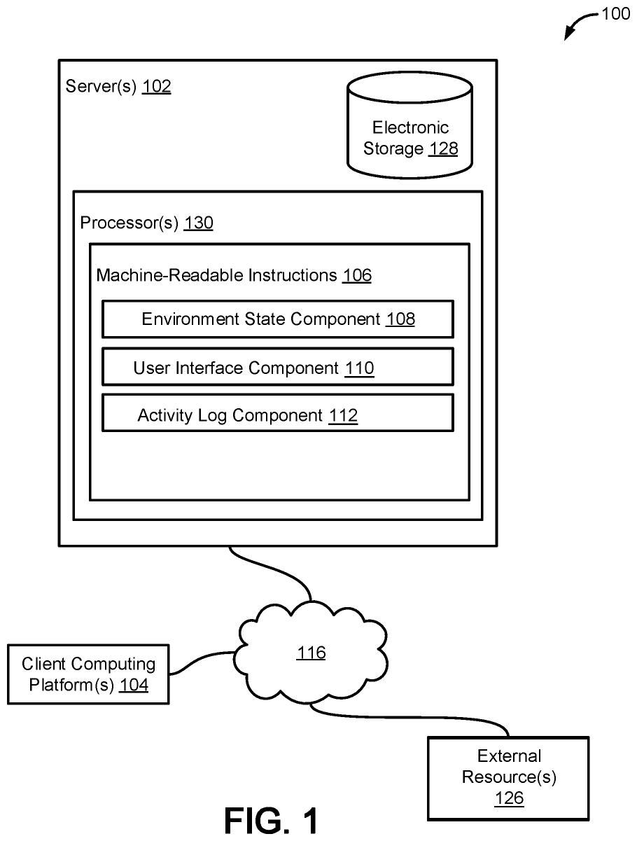

FIG. 1 illustrates a system 100 configured to track user activity within a collaboration environment and/or generate activity logs for activity that accounts for substantive progress toward completion of work, in accordance with one or more implementations. The system 100 may provide an improved user interface functionality within the collaboration environment by tracking user activity and generating activity logs for activity that accounts for substantive progress toward completion of work. The activity logs may be presented within the user interface in a manner which not only provides an indication of the activity that accounts for substantive progress toward completion of work, but also allows for navigation directly to source pages or user interfaces of that activity.

In some implementations, system 100 may include one or more of one or more servers 102, one or more client computing platforms 104, external resource(s) 126, and/or other components. Server(s) 102 may be configured to communicate with one or more client computing platforms 104, one or more external resources 126, and/or other entities of system 100 according to a client/server architecture and/or other architectures. Client computing platform(s) 104 may be configured to communicate with other client computing platforms via server(s) 102 and/or according to a peer-to-peer architecture and/or other architectures. Users may access system 100 and/or instances of the collaboration environment via client computing platform(s) 104. Server(s) 102 may be remote from client computing platform(s) 104. Client computing platform(s) 104 may be remote from each other.

Server(s) 102 may include one or more of non-transitory electronic storage 128, one or more processors 130 configured by machine-readable instructions 106, and/or other components. The non-transitory electronic storage 128 may store environment state information and/or other information. Machine-readable instructions 106 may include one or more instruction components. The instruction components may include computer program components. Executing the machine-readable instructions 106 may cause server(s) 102 to facilitate tracking user activity within a collaboration environment and/or generating activity logs for activity that accounts for substantive progress toward completion of work. The computer program components may include one or more of an environment state component 108, a user interface component 110, an activity log component 112, and/or other components.

Environment state component 108 may be configured to manage the environment state information and/or other information used in maintaining a collaboration environment. The collaboration environment may be configured to facilitate interaction by users with the collaboration environment. The environment state information may include one or more records. The records may include one or more of user records, work unit records, and/or other records. The user records may include user information describing the users of the collaboration environment. The work unit records may include work unit information describing units of work assigned to, created by, and/or managed by the users within the collaboration environment.

The user information in the user records may include values of user parameters and/or other information. The values of the user parameters may be organized in the user records corresponding to users interacting with and/or viewing the collaboration environment. The values of the user parameters may include information describing and/or identifying the users, their actions within the collaboration environment, their settings, metadata associated with the users, work they are members of and/or collaborate on, and/or other user information. Individual ones of the users may be associated with individual ones of the user records. A user record may define values of the user parameters associated with a given user.

The values of the user parameters may, by way of non-limiting example, specify one or more of: a user name, a group, a user account, user role information, a user department, descriptive user content, a to-email, a from-email, a photo, an organization, a workspace, one or more user comments, one or more teams the user belongs to, one or more of the user display settings (e.g., colors, size, project order, task order, other unit of work order, etc.), work inclusion information (e.g., identification of work unit records they are members of and/or collaborate on), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), one or more notification settings, status information for one or more work units the user is associated with (units of work assigned to the user, assigned to other users by the user, completed by the user, past-due date, and/or other information), one or more performance/productivity metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), one or more favorites and/or priorities, schedule information, and/or other information.

Schedule information for the individual users may include one or more calendar entries associated with the individual users. The individual calendar entries may be associated with individual start dates and individual end dates. In some implementations, schedule information may be stored locally within electronic storage 128 by virtue of features and/or functionality provided within a collaboration environment. By way of non-limiting illustration, a collaboration environment may have features and/or functionality of a calendar application configured to facilitate calendaring entries into a schedule. It is noted that schedule information may be determined through features and/or functionality provided by one or more external resources 126. By way of non-limiting illustration, external resources may include a calendar application which may be external to a collaboration environment. The collaboration environment may have permissions to access the external calendar application to determine and/or obtain schedule information.

Work inclusion information may include identification(s) of work unit records that individual users are members of and/or collaborate with one or more other users on.

The “members” of the work unit records may include specifically named users within the work unit records. Specifically naming users may be accomplished by linking user records for those users to the work unit records. Linking the user records to the work unit records may comprise including a referential notation of the user records in the work unit records. Linking the user records to the work unit records may comprise including copies or instances of the user records in the work unit records. In some implementations, users having a particular status with respect to a work unit record may be considered members. By way of non-limiting illustration, users who are designated to perform one or more actions to facilitate completion of the units of work (e.g., assignees, assignors, creators, managers, collaborators, and/or other users) may be considered members. In some implementations, “member” status may be a status that is separate and distinct from users who are actively performing one or more actions to facilitate completion of the units of work. In some implementations, “member” may refer to users who view, access, monitor, and/or otherwise engage with units of work in ways that may not directly facilitate completion of the units of work.

The work unit information in the work unit records may include values of one or more work unit parameters and/or other information. The values of the work unit parameters may be organized in work unit records corresponding to units of work managed, created, and/or assigned within the collaboration environment. A given unit of work may have one or more assignees, owners, and/or collaborators working on the given work unit. Units of work may include one or more of tasks, projects, portfolios, objectives, and/or other units of work.

Work unit records may be created by a given user for the given user and/or created by the given user and assigned to one or more other users. Work unit records may be created by a given user for the given user and/or created by the given user and managed by one or more other users.

Individual units of work may include and/or may be associated with one or more digital content items. An individual unit of work may include an individual digital content item by virtue of the individual digital content item (and/or a copy or instance thereof) being accessible via a work unit page of the unit of work (e.g., via link, URL, a pointer, and/or other techniques to provide access). A digital content item may include one or more of an image, a video, an audio file, a PDF, a word document, multimedia presentations, a webpage, and/or other digital content items.

In some implementations, units of work created by, assigned to, and/or completed by the users may refer generally to a linking of the units of work with the individual users in the collaboration environment. A unit of work may be linked with a user in a manner that defines one or more relationships between the user and the unit of work. Such a relationship may connote and/or be a result of an action (past, present, and/or future) of the user with respect to the unit of work. Such actions may include one or more of creating a work unit record for a unit of work, being assigned to participate in a unit of work, participating in a unit of work, being granted access to a work unit record of a unit of work, adjusting a value of a work unit parameter of a work unit record of a unit of work, being assigned a role at the unit of work level, and/or other actions.

In some implementations, values of work unit parameters may specify one or more of a unit of work name, a unit of work description, user role information, one or more unit of work dates (e.g., a start date, a due date or end date, a completion date, and/or other dates), monetary budget and/or consumption, an amount of work production, project inclusion (e.g., identification of projects supported by the individual units of work), objective inclusion (e.g., identification of objectives supported by the individual units of work), one or more members associated with a unit of work (e.g., an owner, one or more collaborators, collaborator access information, and/or other unit of work collaborators and/or collaborator information), completion state, one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, state of a workspace for a given unit of work (e.g., application state parameters, application status, application interactions, user information, and/or other parameters related to the state of the workspace for a unit of work), one or more progress parameters, one or more performance/productivity metrics for a given unit of work, hierarchical information, dependency information, one or more custom fields (e.g., priority, cost, stage, and/or other custom fields), and/or other information.

In some implementations, work unit parameters may include one or more of a work assignment parameter, a work completion parameter, a work management parameter, a work creation parameter, a dependency parameter, a grouping parameter, a progress parameter, and/or other parameters. The values of the work assignment parameter may describe assignees of individual units of work. The values of the work management parameter may describe users who manage individual units of work and/or the extent in which they manage. The values of the work creation parameter may describe creation characteristics of individual units of work. The creation characteristics may include who created the work unit record, when it was created, and/or other information.

In some implementations, values of a dependency parameter may describe whether a given unit of work is dependent on one or more other units of work. A unit of work being dependent on an other unit of work may mean the unit of work may not be completed, started, assigned, and/or have other interactions performed in relation to the unit of work before some action is performed on the other unit of work. By way of non-limiting illustration, a unit of work may not be started until another unit of work is completed, meaning the unit of work may be dependent on the other unit of work. In some implementations, values of the dependency parameter may go hand in hand with the hierarchical information. By way of non-limiting illustration, a unit of work that is subordinate to an other unit of work may be dependent on the other unit of work or vice versa.

The values of the work assignment parameter describing assignment of users to units of work may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work completion parameter may indicate that a completion status of a unit of work has changed from “incomplete” to “marked complete” and/or “complete.” In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date). In some implementations, a completion status may include one or more of “rejected,” “revisions required,” “incomplete,” and/or other statuses. By way of non-limiting illustration, for units of work that require one user to review work by another user, additional user interface elements may be presented where users can set the status as one or more of “marked complete,” “incomplete,” “rejected,” “revisions required,” and/or other statuses. In some implementations, a status of rejected for a unit of work may be associated with the passing of an end date associated with the unit of work without the work having been marked complete manually. In some implementations, a status of rejected for a unit of work may be associated with a user specifying the unit of work as rejected. In some implementations, a status of revisions required for a unit of work may be associated with a user specifying that the work being reviewed requires changes but is otherwise approved. In some implementations, a status of revisions required may present the reviewing user with options to specify what revisions are required. In some implementations, a status of revisions required may cause a follow-up unit of work to be generated which is assigned back to the assignor of the original work.

In some implementations, values of a grouping parameter may describe whether a given unit of work supports (e.g., is included in) a project and/or objective. The values may specify one or more of a name/title of another work unit record (e.g., project, objective), a name/username of an owner of another work unit record, and/or other information.

In some implementations, values of a progress parameter may include progress information and/or other information. The progress information for the individual units of work may convey progress toward fulfillment of the individual units of work. In some implementations, the progress toward fulfillment of individual units of work may be specified as one or more of a quantitative value, a qualitative value, and/or other information. In some implementations, the quantitative value may be a percentage of completion, a value within a range of values, an integer value, a dollar amount, an amount of activity performed, an amount of work production, and/or other numerical expressions. A qualitative value may include an expression of progress including, but not limited to, “not complete,” “started,” “hallway done,” “nearly fulfilled,” “fulfilled in full,” “complete,” and/or other expressions.

In some implementations, progress toward fulfillment of the individual units of work may be determined based on incremental completion of the units of work that support other units of work (e.g., subtasks that support tasks, tasks that support a project, etc.) and/or other user activity. In some implementations, progress toward fulfillment of the individual units of work may be determined independently from incremental completion of the units of work that support other units of work (e.g., tasks or projects that support a business objective). The completion of the units of work associated with a given unit of work may or may not directly progress the given unit of work toward fulfillment. In some implementations, completion of one or more units of work may make accomplishing other units of work more likely (e.g., through coercion, assistance, education, incentivization, reminder, etc.). However, in some implementations, progress toward fulfillment of individual units of work may be directly determined based on incremental completion of the units of work in the individual sets of units of work.

In some implementations, user activity that causes progress toward fulfillment of work may include one or more of inputting user-generated comments, marking one or more units of work as complete, creating individual work unit records, defining values of one or more parameters of one or more work unit records, conducting and/or completing a meeting, completing and/or performing an action through an external resource, and/or other activity.

In some implementations, progress toward fulfillment of a unit of work may be defined relative to the unit of work itself. In some implementations, units of work of a particular type may be associated with a set of actions that impact progress toward fulfillment. In some implementations, when defining a work unit record for a unit of work, a user may specifically define what activity constitutes progress toward fulfilment of the unit of work.

In some implementations, work unit records may define tasks. The work unit records defining tasks may be referred to as task records. The work unit information in task records may be referred to as task information and/or other information. Task information may include values of work unit parameters for tasks managed within the collaboration environment. The work unit parameters for tasks may be referred to as “task parameters.” The work unit parameters comprising task parameters may be specific to tasks and/or may include one or more parameters not shared with projects, objectives, and/or other records. The task parameters may characterize one or more tasks created, assigned, and/or managed within the collaboration environment and/or via the collaboration environment and/or the metadata associated with the one or more tasks.

In some implementations, work unit records may define projects. The work unit records defining projects may be referred to as project records. The work unit information in project records may be referred to as project information and/or other information. Project information may include values of work unit parameters for projects managed within the collaboration environment. The work unit parameters for projects may be referred to as “project parameters.” The work unit parameters comprising project parameters may be specific to project records and may include one or more parameters not shared with tasks, objectives, and/or other records. The project parameters may characterize one or more projects created, owned, assigned, and/or managed within the collaboration environment and/or via the collaboration environment and/or the metadata associated with the one or more projects. Individual ones of the projects may be associated with individual ones of the records. A given project may have one or more owners and/or one or more collaborators working on the given project. The given project may be associated with one or more other units of work assigned to one or more users under the given project heading. In some implementations, projects may include one or more units of work that may directly facilitate progress toward fulfillment of the projects. Accordingly, completion of units of work may directly contribute to progress toward fulfillment of the project. By way of non-limiting illustration, an individual project may be associated with a client, and the units of work under the individual project heading may be work directly contributing to the fulfillment of a business relationship with the client.

The values of the project parameters may, by way of non-limiting example, include one or more of: one or more units of work associated with individual ones of the projects (which may include values of other work unit parameters defined by one or more work unit records), status information, user role information, one or more user comment parameters (e.g., a creator, a recipient, one or more followers, one or more other interested parties, content, one or more times, upvotes, other hard-coded responses, etc.), a project name, a project description, one or more project dates (e.g., a start date, a due date, a completion date, and/or other project dates), one or more project collaborators (e.g., an owner, one or more other project collaborators, collaborator access information, and/or other project collaborators and/or collaborator information), one or more attachments, notification settings, privacy, an associated URL, one or more interaction parameters (e.g., sources of the interactions, context of the interactions, content of the interactions, time for the interactions, and/or other interaction parameters), updates, ordering of units of work within the given project, state of a workspace for a given task within the given project, and/or other information.

In some implementations, work unit records may define portfolios. The work unit records defining portfolios may be referred to as portfolio records. The work unit information in portfolio records may be referred to as portfolio information and/or other information. Portfolio information may include values of work unit parameters for portfolios managed within the collaboration environment. The work unit parameters for portfolios may be referred to as “portfolio parameters.” The work unit parameters comprising portfolio parameters may be specific to portfolio records and may include one or more parameters not shared with tasks, projects, objectives, and/or other records. The portfolio parameters may characterize one or more portfolios created, owned, assigned, and/or managed within the collaboration environment and/or via the collaboration environment and/or the metadata associated with the one or more portfolios. Individual ones of the portfolios may be associated with individual ones of the records. A given portfolio may have one or more owners and/or one or more collaborators working on the given portfolio. The given portfolio may be associated with one or more other units of work assigned to one or more users under the given portfolio heading. In some implementations, a given portfolio may not have any owners and/or collaborators at the portfolio level other than those specified with respect to the projects subordinate to the portfolio. In some implementations, portfolios may be associated with one or more units of work that may directly facilitate progress toward fulfillment of the portfolios. Accordingly, completion of units of work may directly contribute to progress toward fulfillment of the portfolio. By way of non-limiting illustration, an individual portfolio may be associated with a client, and the units of work under the individual portfolio heading may be work directly contributing to the fulfillment of a business relationship with the client.

The values of the portfolio parameters may, by way of non-limiting example, include and/or specify one or more of: information about one or more projects, tasks, and/or objectives within a given portfolio, information about one or more other portfolios within a given portfolio (which may include values of portfolio parameters defined by one or more other portfolio records), a portfolio name, a portfolio description, a status and/or progress (e.g., an update, a hardcoded status update, a measured status, quantity of units of work remaining in a given project, completed units of work in a given project, and/or other status parameter), one or more attachments, notification settings, privacy settings, an associated URL, one or more interaction parameters (e.g., sources of the interactions, context of the interactions, content of the interactions, time for the interactions, and/or other interaction parameters), updates, ordering of projects within the given portfolio, hierarchical information, permissions information, state of a workspace for a given project within the given portfolio, metadata associated with the portfolios, custom fields (e.g., values created by users), and/or other information.

In some implementations, work unit records may define objectives. The work unit records defining objectives may be referred to as objective records. The work unit information in objective records may be referred to as objective information. The objective information may include values of one or more work unit parameters that define the objectives. The values of the work unit parameters may be organized in objective records corresponding to objectives (sometimes referred to as “business objectives”) managed, created, and/or owned within the collaboration environment. The work unit parameters corresponding to objectives may be referred to as “objective parameters.” The work unit parameters comprising objective parameters may be specific to objectives and may include one or more parameters not shared with tasks and/or projects. A given objective may have one or more collaborators, and/or team members working on the given objective. Objectives may be associated with one or more units of work one or more users should accomplish and/or plan on accomplishing. Objectives may be created by a given user for the given user and/or created by the given user and assigned to be owned to one or more other users. Individual objectives may include one or more of an individual goal, an individual sub-goal, and/or other business objectives assigned to be owned by a user and/or associated with one or more users.

The objectives may be associated with a set of units of work that may indirectly facilitate progress toward fulfillment of the objectives. The set of units of work may not directly contribute to the progress. By way of non-limiting illustration, a connection between the set of units of work and a corresponding objective may be indirect in that completion of at least one of the units of work may have no direct impact on progress toward fulfillment of the objective. The concept of “no direct impact” may mean that completion of the at least one unit of work may not cause progress toward fulfillment of the business objective without independent action outside of the at least one unit of work and/or project. Instead, the fulfillment of the at least one unit of work may make such independent action more likely (e.g., through coercion, assistance, education, incentivization, reminder, etc.). However, in some implementations, objectives may be associated with one or more units of work that may directly facilitate progress toward fulfillment of the objectives. Accordingly, completion of the set of units of work may directly contribute to the progress toward fulfillment. Objectives may be associated with an objectives and key result (OKR) goal-setting framework. Objectives may be specified on one or more of a team basis, organization basis, and/or other specifications. In some implementations, objectives may be characterized as user objectives. User objectives may be specified on an individual user basis. A user objective may be associated with a set of units of work assigned to a user that may indirectly (and/or directly) facilitate progress toward fulfillment of the user objective.

In some implementations, objectives may be described based on one or more of a business objective name, a business objective description, one or more business objective dates (e.g., a start date, a due date, and/or other dates), one or more members associated with a business objective (e.g., an owner, one or more other project/task members, member access information, and/or other business objective members and/or member information), progress information (e.g., an update, a hardcoded status update, a measured status, a progress indicator, quantity value remaining for a given business objective, completed work units in a given project, and/or other progress information), one or more interaction parameters, notification settings, privacy, an associated URL, one or more custom fields (e.g., priority, cost, stage, and/or other custom fields), and/or other information.

The values of the objective owner parameter describing objectives owned by the individual users may be determined based on one or more interactions by one or more users with a collaboration environment. In some implementations, one or more users may create and/or assign ownership of one or more objectives to themselves and/or another user. In some implementations, a user may be assigned to own an objective and the user may effectuate a reassignment of ownership of the objective from the user or one or more other users.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access (or restricted from marking complete) by one or more users unless and/or until a subordinate work unit record is completed and/or started.

Individual work unit records may include hierarchical information defining one or more record hierarchies of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information. In some implementations, a hierarchical arrangement may dictate access to different records within the hierachy based on position and/or other information.

User role information may specify one or more roles of individual users. A role may represent a position of an individual user. A role may represent one or more of how a user works, how a user is expected to work, how a user intends to work, and/or other considerations. The position may be specified based on a description of one or more of a job title, level, and/or other descriptions of position. A role may be specified objectively with respect to a business organization as a whole and/or other specifications. By way of non-limiting illustration, a role may include one or more of the following: chief executive officer (or other officer), owner, manager, supervisor, accountant, associate, employee, intern, entry level, midlevel, senior, administrator, director, foreman, engineer, product developer, human resource officer, artist, art director, and/or other descriptions.

In some implementations, user role information may specify roles of the users within work unit records. A role may convey expected contribution of a user in completing and/or supporting a unit of work. By way of non-limiting illustration, a role within a work unit record may include one or more of owner, manager, creator, reviewer, approver, final decision maker, assignee, assignor, helper, liaison, and/or other descriptions. The individual roles of individual users within some units of work (e.g., a task) may be specified separately from the individual roles of the individual users within other units of work (e.g., a project associated with the task). The individual roles of individual users within the work unit records may be specified separately from the individual roles of the individual users within a business organization as a whole. For example, a business owner may have an “owner” role with respect to a business organization as a whole, while having a “reviewer” role within a project.

In some implementations, environment state information may be continually monitored and/or updated as users interact with the collaboration environment over time. The environment state component 108 may store and/or archive the environment state information continuously, periodically, and/or based on user request to archive. The stored and/or archived environment state information may be referred to as historical environment state information and/or other information.

In some implementations, managing the environment state information by the environment state component 108 may include maintaining queues of work unit records for units of work assigned to the users. The queues may be presented to the users in a user interface of the collaboration environment to facilitate access to the work unit records via work unit pages. Individual queues may represent the work unit records assigned to individual users organized in an order based on the individual end dates and/or other dates (e.g., start dates) and/or other ordering. Individual queues may be presented in a user interface based on one or more spatial arrangements. The particular spatial arrangement used by a user may be stored as part of a user record for the user. The spatial arrangements may include one or more of a list view, a calendar view, a board view, and/or other views. The list view may include a vertical arrangement of graphic icons representing work unit records. The calendar view may be a calendar view by week, by more than one week (e.g., 1^{st} through 15^{th}), by month, by more than one month (e.g., May through July), and/or other calendar views. Units of work may be represented in a calendar view by user interface elements (e.g., icons, calendar entries, etc.). The board view may include a grid of cells comprising columns and rows, where visual content items (e.g., icons) representing work unit records may be positioned in the cells. Columns may be associated with sections (e.g., different hierarchies, groupings, etc.), and the cells within the column may be populated with visual content items representing work unit records that are associated with the sections.

In some implementations, environment state component 108 may be configured to generate and/or manage page information defining work unit pages (sometimes referred to simply as “pages”) corresponding to user records and/or work unit records. Individual work unit pages may provide access to individual records.

Managing information may include one or more of determining, obtaining, receiving, requesting, checking, storing, modifying, and/or other operations. Managing information defining individual work unit pages may include providing information to the user interface component 110 to effectuate presentation of the work unit pages, and/or other information. In some implementations, individual work unit pages may include individual sets of interface elements displaying the values of one or more of the work unit parameters of the individual units of work.

Users may access work unit records via the work unit pages by viewing, adding, changing, deleting, and/or otherwise interacting with values of work unit parameters stored by the work unit records and/or other records. In some implementations, work unit pages providing access to tasks may be referred to as task pages; work unit pages providing access to projects may be referred to as project pages; and work unit pages providing access to objectives may be referred to as objective pages. In some implementations, user pages may include views of the collaboration environment that provide access to user records.

The user interface component 110 may be configured to effectuate communication of user interface information to computing platform(s) 104 associated with the users so that the computing platform(s) 104 present a user interface of the collaboration environment. The user interface information may include page information for pages of the collaboration environment so that the client computing platform(s) 104 present pages through which the users access the work unit records and/or other information.

A user interface of the collaboration environment may provide one or more views of the collaboration environment and/or provide other features and/or functionality. The one or more views may include one or more pages of the collaboration environment. In some implementations, an individual view of the collaboration environment may textually and/or graphically display information (e.g., values of parameters) from one or more of a user record, a task record, a project record, a portfolio record, an objective record, and/or other records. By way of non-limiting illustration, a view may display one or more of a work unit page, a project page, a portfolio page, an objective page, a queue of units of work, and/or other information.

The computing platform(s) 104 may present the work unit pages through which the users access work unit records. Users may provide user input into the work unit pages. The user input may include one or more of selections user interface elements, text additions, drag and drop uploads of digital content items, and/or other user input. Selections may be accomplished through touch-screen input, hovering a cursor and clicking a mouse, entering or typing commands into a command prompt, and/or other types of selections.

The user interface component 110 may be configured to obtain user input information conveying user input into the work unit pages and/or other user interfaces of the collaboration environment. In some implementations, the user input may include selection of a user interface element to mark a task complete, addition of content to a work unit record (e.g., description, title, comments, etc.), up-voting a work unit record, up-voting a comment, creating new work unit records, associating a work unit record with another work unit record, generating a record hierachy, and/or other user input.

The environment state component 108 may be configured to monitor the collaboration environment and/or one or more external resources 126 to identify user activity that impacts progress toward completion of one or more of the units of work of one or more of the work unit records. In particular, user activity that impacts progress toward completion of units of work may account for substantive progress and/or procedural progress. In some implementations, the impact that user activity has on progress toward completion of individual units of work may be classified by impact type. In some implementations, impact types may include one or more of substantive impact type, procedural impact type, and/or other impact types.

User activity of the substantive impact type may include activity that causes distinct and identifiable advancement toward fulfilment of a unit of work. In other words, user activity of the substantive impact type may include activity that causes values of a progress parameter to change. User activity of the procedural impact type may include activity that is merely incidental as a result of performing user activity that causes distinct and identifiable advancement toward fulfilment of a unit of work.

In some implementations, user activity that accounts for substantive progress toward completion of the individual ones of the units of work include one or more of inputting user-generated comments, completing individual work unit records, defining individual work unit records, conducting and/or completing a meeting, completing and/or performing an action through an external resource, and/or other activities.

For example, user activity of completing tasks that support fulfilment of a project may comprise user activity of the substantive impact type. A user may have to log into the collaboration environment in order to mark a task compete. The user activity of logging into the collaboration environment may be user activity of the procedural impact type even though it is a requirement for being able to mark the task complete (which is user activity of the substantive impact type).

By way of non-limiting illustration, a user may instantiate a project record within the collaboration environment by instantiating a set of task records and associating the set of tasks records with the project record. The user may define the project record by writing out a description or goal of the project. The user may define titles and descriptions of the tasks records, and assign users as assignees to one or more of the task records and set start dates and/or due dates of the task records. The user activity of instantiating the project record, instantiating the set of task records, and associating them may be user activity of the procedural impact type even though is it a first step to actually putting the records to use. The user activity of defining the project and making use of the set of tasks by defining them and assigning them to users with start dates and/or due dates may be user activity of the substantive impact type because this activity may allow users to actually begin carrying out work to fulfill the project.

In some implementations, environment state component 108 may be configured to monitor for user activity based on monitoring for updates to values of work unit parameters of one or more work unit records.

In some implementations, environment state component 108 may be configured to identify external user activity in one or more external resources 126 that account for substantive progress toward completion of the individual units of work. By way of non-limiting illustration, environment state component 108 may be configured to perform an application programming interface (API) call and/or other interaction with the external resource(s) to cause the external resource(s) to report instances of user activity. An API interaction may include one or more of Remote Procedure Call, Representational State Transfer, GraphQL, and/or other interaction.

In some implementations, the environment state component 108 may be configured to obtain information indicating occurrence of external user activity that accounts for substantive progress toward completion of the individual units of work. In some implementations, information indicating occurrence of external user activity may be obtained by virtue of individual external resources communicating the information to system 100. The communicated information may include status reports and/or other information. In some implementations, the communication of the information may be based on the environment state component 108 sending requests for the information. In some implementations, the communication of the information may be based on individual external resources performing scheduled and/or predetermined reporting protocols (e.g., push notifications).

In some implementations, external user activity in one or more external resources 126 that account for substantive progress toward completion of the individual units of work may be determined from user activity within the collaboration environment because the one or more external resources 126 may have content embedded within the collaboration environment.

In some implementations, the collaboration environment may include third-party content embedded directly in the collaboration environment. The third-party content may appear within a user interface of the collaboration environment so that the users may not have to continually switch between different application programs to get their work done. A server (e.g., servers(s) 102) hosting the collaboration environment may store an instance of the third-party content within a record structure of the collaboration environment. The server 102 hosting the collaboration environment and a server hosting the features and/or functionality that generates the third-party content (e.g., an external resource) may communicate information back and forth to keep the embedded instance of the third-party content up to date.

The activity log component 112 may be configured to generate, for individual ones of the work unit records, individual activity logs of user activity (within and/or outside the collaboration environment) that account for the substantive progress toward the completion of individual ones of the units of work. In some implementations, an activity log may include a record of the user activity that accounts for the substantive progress. The activity log may identify and/or indicate the user activity through one or more of a description of the activity, identification of user(s) involved in the user activity, identification of one or more records or external resources associated with the user activity, identification of values and/or parameters impacted by the user activity, time-based measures related to the occurrence of the user activity (e.g., start of the activity, end of the activity, duration of the activity, etc.), and/or other information.

The activity log component 112 may be configured to store, in the individual activity logs, one or both of the user activity performed within the collaboration environment or the external user activity performed outside the collaboration environment.

In some implementations, an activity log for a work unit record may be stored within the work unit record as part of the work unit record. In some implementations, an activity log for a work unit record may be stored within the work unit record and one or more other work unit records as part of those work unit records. In some implementations, an activity log for a work unit record may be stored separately from the work unit record. By way of non-limiting illustration, activity logs may be stored separately in activity log records.

By way of non-limiting illustration, a first activity log may be generated for the first work unit record. The first activity log may indicate one or more of the first user activity, the second user activity, and/or other user activity within the collaboration environment that accounts for the substantive progress toward completion of the first unit of work.

The activity log component 112 may be configured to identify, for user activity that accounts for substantive progress toward the completion of the individual ones of the units of work, activity content within the collaboration environment making up the user activity. The activity log component 112 may be configured to identify, for external user activity that accounts for substantive progress toward the completion of the individual ones of the units of work, external activity content of external resource(s) making up the external user activity.

In some implementations, activity content within the collaboration environment making up user activity may include one or more portions of one or more pages of the collaboration environment through which the work unit records are viewed and/or accessed. By way of non-limiting illustration, activity content may comprise comments added by a user, and the comments may be displayed in a portion of a page dedicated to displaying comments. Thus, user activity of adding a comment to a task page may be associated with activity content in the form of a comment section of the task page.

In some implementations, activity content within the collaboration environment making up user activity may include individual pages of the collaboration environment through which the work unit records are marked complete. By way of non-limiting illustration, user activity of marking a task complete may be associated with activity content in the form of a task page for the task having a status indicator as “marked complete.”

In some implementations, external activity content outside the collaboration environment making up external user activity may include one or more portions of a user interface through which the external resources are viewed and/or accessed. By way of non-limiting illustration, external activity content outside of the collaboration environment making up external user activity may include a communication thread of a messaging application where users pose and answer substantive questions for work. By way of non-limiting illustration, external user activity of answering an important question may be associated with external activity content in the form of part of the communication thread.

By way of non-limiting illustration, first activity content may be identified as making up the first user activity, and/or second activity content may be identified as making up the second user activity.

In some implementations, user activity that accounts for substantive progress, and/or the activity content making up the user activity, may be identified by users. By way of non-limiting illustration, users may select activity and/or content within views of the collaboration environment and specify that that content and/or activity should account for substantive progress toward complete of one or more work unit records.

By way of non-limiting illustration, the user interface component 110 may be configured to obtain input information conveying user input into the user interface of the collaboration environment. The user input may include one or more identifications (through entry into the user interface and/or selection of content of the user interface) of the user activity that accounts for the substantive progress toward the completion of individual ones of the units of work. By way of non-limiting illustration, the user interface of the collaboration environment may include one or more user interface elements displayed in association with content of the collaboration environment (e.g., work unit pages, comments, etc.). Selection of a user interface element may cause associated content of the collaboration environment to be defined as the activity content making up the user activity that accounts for the substantive progress toward the completion of a unit of work. A user interface element may include one or more of a virtual bottom, a drop-down menu, a checkbox, and/or other user interface elements.

By way of non-limiting illustration, the first user activity may be identified based on user input that identifies the first user activity as accounting for the substantive progress toward completion of the first unit of work. The first user input may be made, for example, within the context of a work unit page. By way of non-limiting illustration, a work unit page may include a drop-down menu with an option designate completion of a unit of work of the work unit page as accounting for substantive progress toward completion of the first unit of work. By way of non-limiting illustration, the work unit page may include a drop-down menu next to a comment in a comment section with an option designate the comment on the work unit page as accounting for substantive progress toward completion of the first unit of work.

The user interface component 110 may be configured to generate user interface information defining a user interface of the collaboration environment through which individual activity logs are displayed. The display of the individual activity logs within the user interface may include display of instances, or copies, of the activity content. By way of non-limiting illustration, first user interface information may define the user interface through which the first activity log is displayed.

The user interface component 110 may be configured to effectuate presentation of the user interface on computing platform(s) 104 of the users based on the user interface information defining the user interface of the collaboration environment through which individual activity logs are displayed. In some implementations, the user interface component 110 may be configured to obtain, from the one or more external resources, external activity content within the one or more external resources making up the external user activity to cause the user interface displaying the individual activity logs to further display the external activity content.

By way of non-limiting illustration, the user interface displaying the first activity log may be presented on a first computing platform of a first user. The user interface displaying the first activity log may display one or more of an instance of the first activity content, an instance of the second activity content, and/or other content as part of the first activity log of the first work unit record. Presentation may be effectuated by communicating the user interface information defining the user interface of the collaboration environment through which individual activity logs are displayed to client computing platform(s) 104 of the users to cause the client computing platform(s) 104 to display the individual activity logs.

In some implementations, instances of the activity content may be associated with source content. The source content may include a body of content from which the activity content may have originated. Source content may include content within the collaboration environment and/or content outside of the collaboration environment. By way of non-limiting illustration, for activity content comprising one or more user comments, the source content may comprise a work unit record having a work unit page through which the one or more user comments were input. Instances of the activity content may be associated with resource identifiers (e.g., links, pointers, hyperlinks, embedded hyperlinks) that identify source content and/or facilitate access to the source content.

Within the display of an activity log, user selection of instances of the activity content may cause the user interface of the collaboration environment to navigate to source content of the activity content. Responsive to selection of instances of the activity content displayed in the user interface, user interface component 110 may cause the user interface to navigate to pages of the collaboration environment displaying source content of the activity content. By way of non-limiting illustration, responsive to selection of an instance of a comment displayed in the user interface as part of an activity log, user interface component 110 may cause the user interface to navigate to a page of a record that the comment was originally input.

Within the display of an activity log, user selection of instances of the external activity content may cause a user interface of an external resource to be presented on their computing platform.

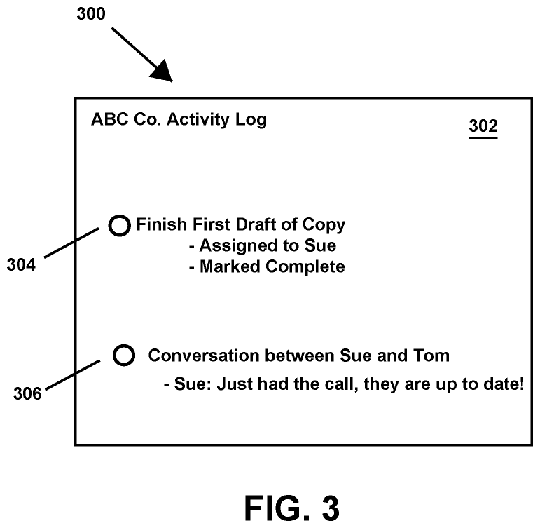

FIG. 3 illustrates a user interface 300 of a collaboration environment, in accordance with one or more implementations. The user interface 300 may include a view of a collaboration environment. In particular, the user interface 300 may comprise a page 302 displaying an activity log. The activity log may be associated with a work unit record for a unit of work, such as a project (“ABC Co.”). The page 302 may comprise a subset of a work unit page (e.g., project page) of the project. The activity log may indicate user activity that accounts for substantive progress toward the completion of the project, and display instances of activity content associated with the user activity. By way of non-limiting illustration, a user interface element 304 may indicate a first user activity (e.g., marking a task complete) and display an instance of first activity content associated with the first user activity. The first user activity may include completing a unit of work that supports the project, and the first activity content may include information from a work unit page for the unit of work. The information from the work unit page may include values of one or more parameters including, but not limited to, title, assignee, completion status, and/or other information. A user interface element 306 may indicate a second user activity and display an instance of second activity content associated with the second user activity. The second user activity may include a communication activity within an external application, such as a chat application. The second activity content may include a portion of a chat session conducted within a user interface of the external application. The second activity may include having a call to update the client on the project. The second activity content may include a confirmation of that activity in a chat session.

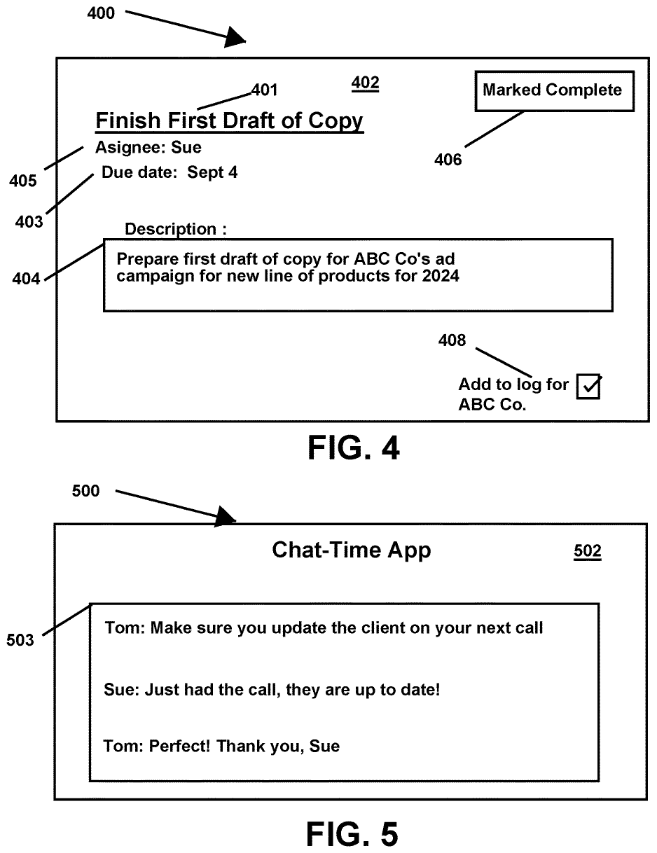

Selection of instances of the activity content of the activity log in FIG. 3 may cause the user interface 300 to navigate to views of source content including the activity content. By way of non-limiting illustration, selection of user interface element 304 (and/or the accompanying text) may cause the user interface 300 to navigate to a work unit page for the task that was marked complete (see, e.g., FIG. 4). By way of non-limiting illustration, selection user interface element 306 (and/or the accompanying text) may cause a user interface of the external resource to be presented that includes the chat session (or portion thereof) where the second user activity was derived (see, e.g., FIG. 5).

FIG. 4 illustrates a user interface 400 of a collaboration environment, in accordance with one or more implementations. The user interface 400 may include a view of a collaboration environment. In particular, the user interface 400 may comprise a work unit page 402 for a task through which users access a work unit record for the task. The work unit record may show the task as “marked complete.” The completion of the task may account for substantive progress toward completion of another unit of work, such as a project. The user interface 400 may display values of one or more work unit parameters and/or other information. By way of non-limiting illustration, a user interface element 401 may display a title of the task (e.g., “Finish First Draft of Copy”). A user interface element 405 may display an assignee of the task (e.g., “Sue”). A user interface element 403 may display a due date of the task (e.g., “Sept 4”). A user interface element or portion 404 may display a description of the task. A user interface element 406 may be configured to receive user input to change a completion status, e.g., mark the task as complete via a virtual button.

The user work unit page 402 may provide the basis for activity content. The work unit page 402 may be navigated to in response to selection of an instance of activity content representing the work unit page 402 from an activity log (see, e.g., FIG. 3). A user interface element 408 may be configured to receive user input that identifies marking the task as complete as being user activity that accounts for substantive progress toward completion of the project (“ABC Co.”).

FIG. 5 illustrates a user interface 500 of an external resource, in accordance with one or more implementations. By way of non-limiting illustration, the external resource may include a chat application. The user interface 500 may comprise a view of a chat session 502 facilitated through the external 503. By way of non-limiting illustration, the user interface may display a chat window 502 for a chat session through which users communicate synchronously and/or asynchronously.

The chat session 502 may provide the basis for activity content. The user interface 500 showing the chat session 502 may be navigated to in response to selection of an instance of activity content representing the chat session 502 from an activity log (see, e.g., FIG. 3). The chat window 503 may include a series of text messages entered by participants, e.g., Tom and Sue. The content of the chat session in the chat window 503 may serve as the source content for the second activity content, and may provide additional messages between the participants.

Referring back to FIG. 1, in some implementations, server(s) 102, client computing platform(s) 104, and/or external resource(s) 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resource(s) 126 may be operatively linked via some other communication media.

A given client computing platform may include one or more processors configured to execute computer program components. The computer program components may be configured to enable an expert or user associated with the given client computing platform to interface with system 100 and/or external resource(s) 126 and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resource(s) 126 may include sources of information outside of system 100, external entities participating with system 100, and/or other resources. In some implementations, some or all the functionality attributed herein to external resource(s) 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112 and/or other components. Processor(s) 130 may be configured to execute components 108, 110, 112 and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

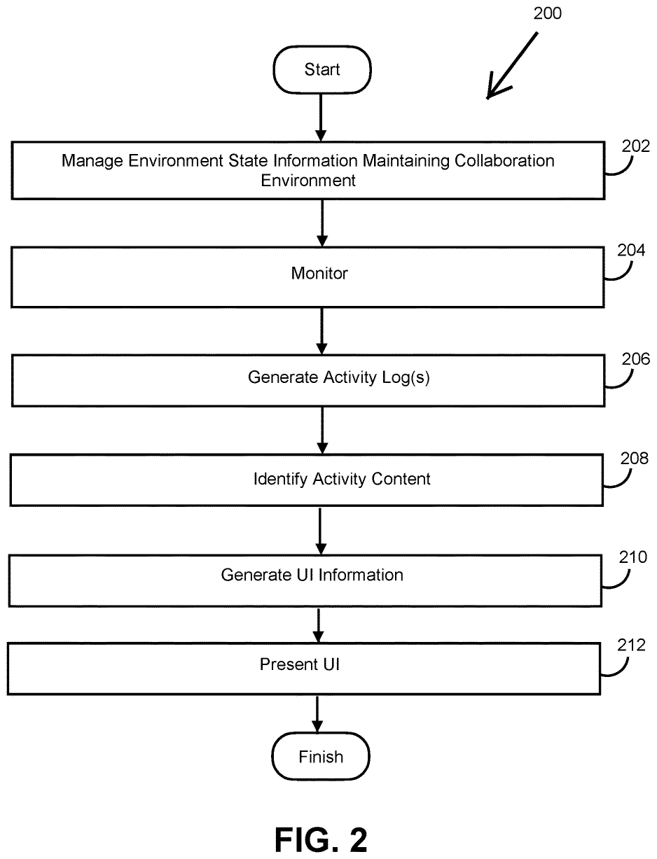

FIG. 2 illustrates a method 200 to track user activity within a collaboration environment and/or generate activity logs for activity that accounts for substantive progress toward completion of work, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment. The collaboration environment may be configured to facilitate interaction by users with the collaboration environment. The environment state information may include one or more records. The records may include work unit records and/or other records. The work unit records may describe units of work created, managed, and/or assigned within the collaboration environment. By way of non-limiting illustration, the work unit records may include a first work unit record for a first unit of work. Operation 202 may be performed by one or more hardware processors configured by machine-readable instructions including a component that is the same as or similar to environment state component 108 (shown in FIG. 1 and described herein), in accordance with one or more implementations.

An operation 204 may monitor the collaboration environment to identify user activity that accounts for substantive progress toward completion of one or more of the units of work of one or more of the work unit records. By way of non-limiting illustration, identified user activity may include one or more of first user activity, second user activity, and/or other user activity within the collaboration environment that accounts for the substantive progress toward completion of the first unit of work. Operation 204 may be performed by one or more hardware processors configured by machine-readable instructions including a component that is the same as or similar to environment state component 108 (shown in FIG. 1 and described herein), in accordance with one or more implementations.

An operation 206 may generate, for individual ones of the work unit records, individual activity logs of user activity that account for the substantive progress toward the completion of individual ones of the units of work. By way of non-limiting illustration, a first activity log may be generated for the first work unit record. The first activity log may indicate one or more of the first user activity, the second user activity, and/or other user activity within the collaboration environment that accounts for the substantive progress toward completion of the first unit of work. Operation 206 may be performed by one or more hardware processors configured by machine-readable instructions including a component that is the same as or similar to activity log component 112 (shown in FIG. 1 and described herein), in accordance with one or more implementations.

An operation 208 may identify, for the user activity that accounts for the substantive progress toward the completion of the individual ones of the units of work, activity content within the collaboration environment making up the user activity. By way of non-limiting illustration, first activity content may be identified as making up the first user activity, and second activity content may be identified as making up the second user activity. Operation 208 may be performed by one or more hardware processors configured by machine-readable instructions including a component that is the same as or similar to activity log component 112 (shown in FIG. 1 and described herein), in accordance with one or more implementations.

An operation 210 may generate user interface information defining a user interface of the collaboration environment. The user interface may display individual activity logs. The display of the individual activity logs within the user interface may include display of instances of the activity content. By way of non-limiting illustration, first user interface information may define the user interface through which the first activity log is displayed. Operation 210 may be performed by one or more hardware processors configured by machine-readable instructions including a component that is the same as or similar to user interface component 110 (shown in FIG. 1 and described herein), in accordance with one or more implementations.

An operation 212 may effectuate presentation of the user interface on computing platforms of the users based on the user interface information and/or other information. By way of non-limiting illustration, the user interface displaying the first activity log may be presented on a first computing platform of a first user. The user interface may display the first activity by including one or more of an instance of the first activity content, an instance of the second activity content, and/or other content as part of the first activity log of the first work unit record. Selections of the instance of activity content may cause the user interface to navigate to source pages that include the activity content. Operation 212 may be performed by one or more hardware processors configured by machine-readable instructions including a component that is the same as or similar to user interface component 110 (shown in FIG. 1 and described herein), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to provide navigation through pages of a user interface based on activity logs listing activity that accounts for substantive progress toward completion of work, the system comprising:
one or more physical processors configured by machine-readable instructions to:
manage, by a server hosting a collaboration environment, environment state information maintaining the collaboration environment, the collaboration environment being configured to facilitate interaction by users with the collaboration environment, the users interacting with the collaboration environment through instances of a graphical user interface, the instances of the graphical user interface being presented via remotely located client computing platforms communicating with the server over one or more network connections, the environment state information including work unit records, the work unit records describing units of work created, managed, and/or assigned within the collaboration environment, wherein one of the work unit records corresponds to one of the units of work, the work unit records including a first work unit record corresponding to a first unit of work assigned to a first user, and a second work unit record corresponding to a second unit of work assigned to the first user;
establish the one or more network connections between the server and the remotely located client computing platforms;
monitor, by the server, the collaboration environment to identify user activity from the interaction by the users with the instances of the graphical user interface that accounts for substantive progress toward completion of one or more of the units of work described in one or more of the work unit records, such that the user activity includes first user activity and second user activity within the collaboration environment that account for the substantive progress toward completion of the first unit of work;
generate, by the server and for individual ones of the work unit records, individual activity logs of the user activity that accounts for the substantive progress toward the completion of individual ones of the units of work, a first activity log being generated for the first work unit record, the first activity log indicating the first user activity and the second user activity;
for the user activity that accounts for the substantive progress toward the completion of the individual ones of the units of work, identify, by the server, activity content within the collaboration environment making up the user activity, such that first activity content is identified as making up the first user activity, and second activity content is identified as making up the second user activity;
generate, by the server, user interface information defining the instances of the graphical user interface through which the individual activity logs are displayed, wherein display of the individual activity logs includes display of instances of the activity content, such that first user interface information defines a first instance of the graphical user interface through which the first activity log is displayed;
effectuate communication of the user interface information from the server to the remotely located client computing platforms over the one or more network connections to cause presentation of the instances of the graphical user interface on the remotely located client computing platforms of the users based on the user interface information, such that the first instance of the graphical user interface displaying the first activity log is presented on a first remotely located client computing platform associated with a second user, the first instance of the graphical user interface displaying an instance of the first activity content and an instance of the second activity content as part of the first activity log of the first work unit record; and
responsive to selection of the instances of the activity content displayed in the instance of the graphical user interface, update, by the server, the user interface information to cause the instances of the graphical user interface to navigate from displays of the individual activity logs to individual pages of the collaboration environment displaying source content of the activity content.

2. (canceled)

3. The system of claim 1, wherein the user activity that accounts for the substantive progress toward completion of the individual ones of the units of work include one or more of inputting user-generated comments, completing individual work unit records, defining individual work unit records, conducting and/or completing a meeting, or completing and/or performing an action through an external resource.

4. The system of claim 1, wherein the one or more physical processors are further configured by the machine-readable instructions to:
obtain input information conveying user input into the instances of the graphical user interface of the collaboration environment, the user input including one or more identifications of the user activity that accounts for the substantive progress toward the completion of the individual ones of the units of work, such that the first user activity is identified based on user input that identifies the first user activity as accounting for the substantive progress toward completion of the first unit of work.

5. The system of claim 4, wherein the instances of the graphical user interface of the collaboration environment includes a user interface element displayed in association with content of the collaboration environment, such that selection of the user interface element causes associated content of the collaboration environment to be defined as the activity content making up the user activity that accounts for the substantive progress toward the completion of the individual ones of the units of work.

6. The system of claim 5, wherein the user interface element is displayed as part of a drop-down menu.

7. The system of claim 1, wherein the activity content within the collaboration environment making up the user activity includes one or more portions of one or more pages of the collaboration environment through which the work unit records are viewed.

8. The system of claim 1, wherein the one or more physical processors are further configured by the machine-readable instructions to:
identify external user activity in one or more external resources that account for substantive progress toward completion of the individual ones of the units of work;
store, in the individual activity logs, the user activity and the external user activity.

9. The system of claim 8, wherein the one or more physical processors are further configured by the machine-readable instructions to:
obtain, from the one or more external resources, external activity content within the one or more external resources making up the external user activity; and
cause the instances of the graphical user interface displaying the individual activity logs to further display the external activity content.

10. The system of claim 9, wherein the external activity content is embedded within the collaboration environment, and identification of the external user activity is performed by user selection of the external activity content making up the external user activity.

11. A method to provide navigation through pages of a user interface based on activity logs listing activity that accounts for substantive progress toward completion of work, the method comprising:
managing, by a server hosting a collaboration environment, environment state information maintaining the collaboration environment, the collaboration environment being configured to facilitate interaction by users with the collaboration environment, the users interacting with the collaboration environment through instances of a graphical user interface, the instances of the graphical user interface being presented via remotely located client computing platforms communicating with the server over one or more network connections, the environment state information including work unit records, the work unit records describing units of work created, managed, and/or assigned within the collaboration environment, wherein one of the work unit records corresponds to one of the units of work, the work unit records including a first work unit record corresponding to a first unit of work assigned to a first user, and a second work unit record corresponding to a second unit of work assigned to the first user;
establishing the one or more network connections between the server and the remotely located client computing platforms;
monitoring, by the server, the collaboration environment to identify user activity that accounts for substantive progress toward completion of one or more of the units of work described in one or more of the work unit records, including identifying first user activity and second user activity within the collaboration environment that account for the substantive progress toward completion of the first unit of work;
generating, by the server and for individual ones of the work unit records, individual activity logs of the user activity that accounts for the substantive progress toward the completion of individual ones of the units of work, including generating a first activity log for the first work unit record, the first activity log indicating the first user activity and the second user activity;
for the user activity that accounts for the substantive progress toward the completion of the individual ones of the units of work, identifying, by the server, activity content within the collaboration environment making up the user activity, including identifying first activity content making up the first user activity, and second activity content making up the second user activity;
generating, by the server, user interface information defining the instances of the graphical user interface through which the individual activity logs are displayed, wherein display of the individual activity logs includes display of instances of the activity content, including generating first user interface information defining a first instance of the graphical user interface through which the first activity log is displayed;
effectuating communication of the user interface information from the server to the remotely located client computing platforms over the one or more network connections to cause presentation of the instances of the graphical user interface on the remotely located client computing platforms of the users based on the user interface information, including effectuating presentation of the first instance of the graphical user interface displaying the first activity log on a first remotely located client computing platform associated with a second user, the first instance of the graphical user interface displaying an instance of the first activity content and an instance of the second activity content as part of the first activity log of the first work unit record; and
responsive to selection of the instances of the activity content displayed in the instance of the graphical user interface, updating, by the server, the user interface information to cause the instances of the graphical user interface to navigate from displays of the individual activity logs to individual pages of the collaboration environment displaying source content of the activity content.

12. (canceled)

13. The method of claim 11, wherein the user activity that accounts for the substantive progress toward completion of the individual ones of the units of work include one or more of inputting user-generated comments, completing individual work unit records, defining individual work unit records, conducting and/or completing a meeting, or completing and/or performing an action through an external resource.

14. The method of claim 11, further comprising:
obtaining input information conveying user input into the instances of the graphical user interface of the collaboration environment, the user input including one or more identifications of the user activity that accounts for the substantive progress toward the completion of the individual ones of the units of work, such that the first user activity is identified based on user input that identifies the first user activity as accounting for the substantive progress toward completion of the first unit of work.

15. The method of claim 14, wherein the instances of the graphical user interface of the collaboration environment includes a user interface element displayed in association with content of the collaboration environment, such that selection of the user interface element causes associated content of the collaboration environment to be defined as the activity content making up the user activity that accounts for the substantive progress toward the completion of the individual ones of the units of work.

16. The method of claim 15, wherein the user interface element is displayed as part of a drop-down menu.

17. The method of claim 11, wherein the activity content within the collaboration environment making up the user activity includes one or more portions of one or more pages of the collaboration environment through which the work unit records are viewed.

18. The method of claim 11, further comprising:
identifying external user activity in one or more external resources that account for substantive progress toward completion of the individual ones of the units of work; and
storing, in the individual activity logs, the user activity and the external user activity.

19. The method of claim 18, further comprising:
obtaining, from the one or more external resources, external activity content within the one or more external resources making up the external user activity; and
causing the instances of the graphical user interface displaying the individual activity logs to further display the external activity content.

20. The method of claim 19, wherein the external activity content is embedded within the collaboration environment, and identification of the external user activity is performed by user selection of the external activity content making up the external user activity.
